(19) United States
(12) Patent Application Publication
(10) Pub. No.: US 2002/0102092 A1
(43) Pub. Date: Aug. 1, 2002

(54) RF passthrough for digital network recorders

(75) Inventor: Phuoc M. Thai, El Cajon, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Corporation and Sony Electronics Inc.

(21) Appl. No.: 09/773,406

(22) Filed: Jan. 31, 2001

(51) Int. Cl. H04N 7/26

(52) U.S. Cl. 386/46; 386/111

(57) ABSTRACT

A method of implementing an RF passthrough for a digital network recorder, and a means for practicing the method, the method consists of the steps of: monitoring an output of a digital video decoder of a digital network recorder that continuously records an input television signal to a memory and continuously decodes and plays the input television signal having been recorded; and outputting the input television signal to a television, in the event an output video signal is not output from the digital video decoder, wherein the output video signal comprises the input television signal having been previously recorded and decoded. For example, the input television signal is passed through to the television during the booting up process or a failure of the digital network recorder.

### FIELD OF THE INVENTION

The present invention relates to recorders for recording and playing an input television signal, and more specifically, the invention relates to digital network recorders that receive updates from a network and that records and plays an input television signal.

### BACKGROUND OF THE INVENTION

A television video recording unit (also known in the art as a digital hard disk video recorder or a digital network recorder) is a device which inputs a television signal, e.g. a television RF signal, continuously records the television signal and then outputs the television signal having been recorded to a television for the user to view. The input television signal may be received from an antenna system, a cable delivery system, or a satellite receiver, for example. Internally, the television recording unit includes a large hard disk drive for storing the television signal. The recording and playing feature is governed by an operating system stored on the hard drive. The operating system behaves as an operating system on a computer; thus, the digital network recorder combines the functionality of a personal computer (PC) with that of a video cassette recorder (VCR). Further included within the digital network recorder is encoder functionality for digitizing the input television signal (in the case of an analog input television signal), and encoding and compressing the signal for storage on the hard drive. Decoder functionality then decodes and decompresses the stored television signal and provides an output television signal (in either analog or digital format depending on the television type) to the television which is time shifted with respect to the input television signal by a short period of time depending on the speed of the digital network recorder, e.g., typically only a few seconds.

Advantageously, since the live television RF signal is continuously being recorded, the user may actually pause, rewind, or replay the live television signal. The user can simply fast forward back to real time to catch up to the “live” television signal.

Disadvantageously, since the digital network recorder is similar to a computer and requires an operating system, the operating system must “boot up” or initialize at power on. Thus, when the digital network recorder is powered on, the system must load the operating system from the hard drive into random access memory and ensure that all the necessary components of the digital network recorder are functioning before beginning to record the input television signal. Thus, while “booting up”, known digital network recorders can not supply an output television signal to the television.

Unfortunately, this results in the television displaying a blank screen during the boot up process, or optionally, a screen display indicating that the digital network recorder is loading. Depending on the operating system, the boot up time may be from 1 to 5 minutes in duration. This delay from when the user powers on the digital network recorder until the user is able to view the television can be extremely irritating and frustrating to viewers. Television viewers are accustomed to powering on a television and immediately viewing programming, as is common to the majority of television delivery systems; thus, even a wait time of one minute may seem an eternity to the normal television viewer.

Another problem common to digital network recorders is that if there is a crash in the hard drive of the recorder, the output television signal is interrupted such that no television signal is output to the television. Thus, the user may be unable to view any television signal in the event of a hard drive crash. Also, if the hard drive crash occurs during the boot up process, the user may be unaware of the crash and get frustrated waiting and waiting for the boot up process to finish (which will not happen in the event of a crash during boot up).

The present invention advantageously addresses the above and other needs.

### SUMMARY OF THE INVENTION

The present invention advantageously addresses the needs above as well as other needs by providing an RF passthrough within the digital network recorder to pass the input television signal directly through to the television in the event that there is no video output from the digital network recorder.

In one embodiment, the invention can be characterized as a method, and a means for practicing the method, the method including the steps of: monitoring an output of a digital video decoder of a digital network recorder that continuously records an input television signal to a memory and continuously decodes and plays the input television signal having been recorded; and outputting the input television signal to a television, in the event an output video signal is not output from the digital video decoder, wherein the output video signal comprises the input television signal having been previously recorded and decoded.

In another embodiment, the invention can be characterized as an RF passthrough system for a digital network recorder including a memory for continuously storing an input television signal as digital data and a digital video decoder coupled to the memory for continuously retrieving the digital data, decoding the digital data and outputting an output video signal. The output video signal represents the input television signal and is to be output to a television coupled to the digital network recorder. The system also includes a switch for inputting the input television signal and the output video signal such that the switch outputs the input television signal in the event the output video signal is not input from the digital video decoder.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a diagram of a system including a conventional digital network recorder for recording television signals and displaying on a television an indication that the digital network recorder is booting up;

FIG. 2 is a functional block diagram of the conventional digital network recorder of FIG. 1;

FIG. 3 is a functional block diagram of a digital network recorder incorporating an RF passthrough in accordance with one embodiment of the invention;

FIG. 4 is an internal block diagram illustrating several components found within one variation of the conventional digital network recorder of FIG. 1;

FIG. 5 is an internal block diagram of one embodiment of the digital network recorder of FIG. 3 in accordance with one embodiment of the invention; and

FIG. 6 is a flowchart of the steps performed by the digital network recorder of FIGS. 3 and 5 in accordance with another embodiment of the invention.

Corresponding reference characters indicate corresponding components throughout the several views of the drawings.

### DETAILED DESCRIPTION OF THE PREFERRED EMBODIMENTS

The following description of the presently contemplated best mode of practicing the invention is not to be taken in a limiting sense, but is made merely for the purpose of describing the general principles of the invention. The scope of the invention should be determined with reference to the claims.

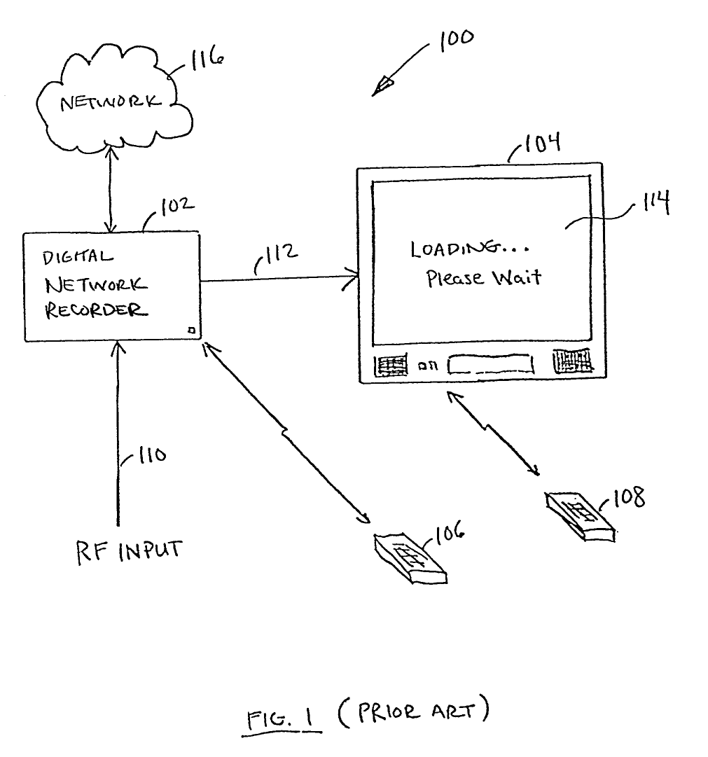

Referring first to FIG. 1, a diagram is shown of a system 100 including a conventional digital network recorder for recording television signals and displaying on a television an indication that the digital network recorder is booting up. Shown is a digital network recorder 102, a television 104, a recorder remote control 106, a television remote control 108, an input television signal 110 (also referred to as the raw television signal), an output television signal 112, a computer network 116 and a screen display 114.

The digital network recorder 102 is known in the art as a device which receives an input television signal 110, e.g. a television RF signal, records the television signal 110 and then produces the output television signal 112 which is sent to the television 104. The digital network recorder 102 is also referred to in the art as a network video recorder, a hard disk video recorder, or a digital personal video recorder. An example of such a device is the Sony Digital Network Recorder SVR-2000, commercially available from Sony Electronics Inc., of Park Ridge, N.J., which incorporates TiVO Service™ developed by TiVo, Inc. of Sunnyvale, Calif. Another example is the Panasonic PV-HS2000 Showstopper Hard Disk Recorder, commercially available from Matsushita Electronics Corporation of America headquartered in New Jersey, which uses Replay TV Service developed by RePlay TV, Inc., of Mountain View, Calif.

The input television signal 110 may be received from an antenna system, a cable delivery system (e.g. cable modem or a cable set top box), or a satellite receiver, for example. Typically, the input television signal 110 is referred to as an RF input, since television signals are commonly modulated on a radio frequency (RF) carrier. Internally, the digital network recorder 102 includes a large hard disk drive (e.g. a 30 Gbyte hard disk) for storing the input television signal 110. The recording and playing feature is governed by an operating system stored on the hard drive. The operating system behaves as an operating system on a computer; thus, the digital network recorder 102 combines the functionality of a PC with that of a VCR. For example, the Sony SVR-2000 utilizes a LINUX operating system, while the Panasonic PV-HS2000 utilizes a WINDOWS operating system. Further included within the television recording unit 102 is encoder functionality for digitizing the input television signal 110 (in the event the input television signal 110 is analog), encoding and compressing the input television signal 110 for storage on the hard drive. For example, the input television signal 110 is encoded using the motion picture experts group 2 standard (MPEG2) as known in the art. Decoder functionality then decodes and decompresses the stored data representing the input television signal 110 and provides an output television signal 112 (in either analog or digital format depending on the television type) to the television 104.

Thus, in effect, the digital network recorder buffers the input television signal. Advantageously, since the live input television signal 110 is continuously being recorded by the digital network recorder 102, the user may actually pause the output television signal 112, e.g. to answer a telephone or to use the restroom. Similarly, the user may rewind the television broadcast to watch a portion over again, e.g., to see a user created instant replay. The user can simply fast forward back to real time to catch up to the “live” input television signal 110. It is noted that such digital network recorders are known in the art “time shifting devices” since the output television signal 112 is shifted in time about 1-2 seconds with respect to the input television signal 110 due to the continuous recording of the input television signal 110.

Additionally, the digital network recorder 102 is referred to as a network recorder, since the digital network recorder 102 includes a modem (not shown) for coupling the digital network recorder 102 to a computer network 116, e.g., the Internet. This enables the digital network recorder 102 to receive updates and control information from services in the computer network 116 that manage the digital network recorder 102. For example, the Sony SVR-2000 periodically dials into the TiVo Service server, which downloads programming schedules and other information to the digital network recorder. It is noted that this feature is well known and understood in the art.

Disadvantageously, since the digital network recorder 102 is similar to a computer and requires an operating system, the operating system must “boot up” or initialize at power on. Thus, when the digital network recorder 102 is powered on, the operating system must be loaded from the hard drive into random access memory and ensure that all the necessary components of the digital network recorder 102 are functioning prior to being able to begin recording the input television signal 110. In the context of the Sony SVR-2000, the “power on” which requires booting up occurs when power is supplied to the digital network recorder 102, not when the user powers on and off the digital network recorder 102 with the recorder remote control 106. However, it is noted that “power on” which requires booting up for other digital network recorders may occur at other times, e.g., while powering on the digital network recorder 102 with its remote control 106. Additionally, the output television signal 112 is the signal retrieved from storage on the hard drive and decoded by the decoder. This output television signal 112 may be digital or analog depending on the television 104. Thus, while “booting up”, conventional digital network recorders 102 do not supply the output television signal 112 to the television 104.

Unfortunately, this results in the television 104 displaying a blank screen during the boot up process, or optionally a screen display 114 indicating that the digital network recorder 102 is loading. Depending on the operating system, the boot up time may be from 1 to 5 minutes in duration. For example, digital network recorders 102 using a LINUX operating system take about 3-5 minutes to boot up, while a WINDOWS operating system takes about 1-2 minutes to boot up. This delay from when the user powers on the digital network recorder 102 until the user is able to view programming on the television 104 can be extremely irritating and frustrating to viewers. Television viewers are accustomed to powering on a television 104 and immediately viewing programming, as is common to the majority of television delivery systems (e.g. antenna, cable, and satellite); thus, even a wait time of one minute may seem an eternity to the normal television viewer.

Furthermore, in digital network recorders 102 where power on requiring the boot-up process occurs when the user operates the remote control 106 on/off button, the problem of not being able to view the television signal during boot up occurs frequently. Most users are accustomed to powering on and off the television 104 with the same remote unit that changes the channels, adjusts the volume, etc., which is the recorder remote control 106 unit in this case, not the television remote control 108. Thus, many users, while operating the digital network recorder 102 with the recorder remote control 106, will accidentally hit the power button turning off the digital network recorder 102, then use television remote control 108 to turn off the television 104. This would be more likely with users not accustomed to operating the television 104 using other than the television remote control 108 supplied by the manufacturer, for example, users who do not have a cable set top box or a satellite receiver. Thus, unfortunately at power on, the user must endure the boot up process without being able to view the output television signal 112.

In digital network recorders 102, such as the Sony SVR-2000, where powering on and off the digital network recorder via the recorder remote control 106 does not initiate the boot up process, the problem still exists. In this case, boot up is required when power is initially supplied to the digital network recorder 102 or power is removed and re-connected, either physically or with a switch. For example, the user will be unable to watch the television for several minutes when the user plugs the digital network recorder 102 into the power outlet. Furthermore, many users operate their the digital network recorder 102 with the use of a switched power supply, controlled by a switch on an electrical outlet strip or a light switch, for example. In these cases, the user will cause the power to be disconnected from the digital network recorder 102 such that during the re-connection (e.g., by activating the switch), the user must endure the boot up process before being able to watch television. As such, disadvantageously, the user must endure the boot up process without being able to watch the output television signal 112.

Another problem common to digital network recorders 102 is that if there is a crash in the hard drive of the digital network recorder 102, the output television signal 112 is interrupted such that no television signal is output to the television 104. Thus, the user may be unable to view any television signal in the event of a hard drive crash. Also, if the hard drive crash occurs during the boot up process, the user may be unaware of the crash and get frustrated waiting and waiting for the boot up process to finish (which does not happen in the event of a crash during boot up).

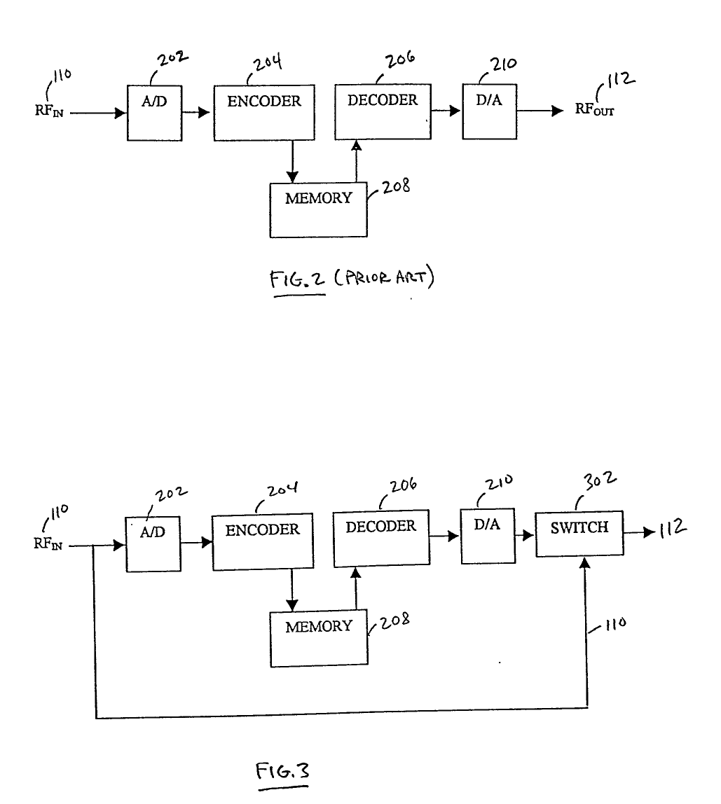

Referring next to FIG. 2, a functional block diagram is shown of the conventional digital network recorder of FIG. 1. Shown is the input television signal 110 (also referred to as a raw input television signal 110), an analog to digital converter 202 (hereinafter referred to as the A/D converter 202), an encoder 204 (also referred to as a digital video encoder), a decoder 206 (also referred to as a digital video decoder), a memory 208, and a digital to analog converter 210 (hereinafter referred to as the D/A converter 210).

The input television signal 110 is input into the digital network recorder and is converted to digital format by the A/D converter 202. It is noted that the A/D converter 202 may be unnecessary in embodiments in which the input television signal 110 is already in digital format, e.g., if the input television signal 110 is from an s-video or RCA input. Next, the digital signal is encoded at the encoder 204. The encoder 204 encodes and compresses the input television signal 110 according to a coding scheme, such as the MPEG2 standard. The encoded and compressed digital data representing the input television signal 110 is then stored within the memory 208. This memory 208 is conventionally a hard disk drive, e.g., a 30 Gbyte hard disk.

As soon as the input televison signal is stored in memory, the decoder 206 continuously retrieves the stored data from memory 208 and decodes the stored data (e.g., using the MPEG2 standard) and forms a digital signal to be output to the television. If the television accepts only analog signals, then the D/A converter 210 converts the output television signal 112 to analog. Otherwise the D/A converter 210 is not used if the television is a digital television.

As seen, when there is no output from the decoder 206, there is no output television signal 112 to the television. This occurs while the operating system is booting up or when there is a hard drive crash, for example. Consequently, as described above, the viewer can not view any television.

Referring next to FIG. 3, a functional block diagram is shown of a digital network recorder incorporating an RF passthrough in accordance with one embodiment of the invention. Shown is the input television signal 110 (also referred to as the raw input television signal 110), the A/D converter 202, the encoder 204 (also referred to as a digital video encoder), the decoder 206 (also referred to as a digital video decoder), the memory 208, the D/A converter 210, a switch 302, and the output television signal 112.

This embodiment of the invention includes the same basic functions as the digital network recorder of FIG. 2, but includes the addition of the switch 302 that inputs the output of the decoder 206 and the input television signal 110. The switch 302 selects one of the two inputs as the output televison signal 112 to the television. Thus, the input television signal 110 is coupled to the A/D converter 202 and to the switch 302. As such, the switch 302 is configured to automatically output the input television signal 110 as the output television signal 112 in the event there is no output from the decoder 206 received at the switch 302. When there is an output from the decoder 206 and D/A converter 210, the raw input television signal 110 is overwritten by the output of the decoder 206.

Advantageously, this solution covers the boot up scenario. For example, when booting up, the switch 302 is configured to by-pass all elements under the control of the operating system. The switch 302 detects no output at the decoder 206 and D/A converter 210. When the system is fully booted up and the decoder 206 is functioning (i.e., producing a video output signal), then the switch 302 causes the recorded television signal (i.e., the video output of the decoder 206) to be the output television signal 112.

Likewise, in the event of a hard drive crash or other failure, the decoder 206 will not output a signal, and the switch 302 will cause the raw input television signal 110 to be the output television signal 112. Thus, the switch 302 is configured to always output the raw input television signal 110 unless there is a video output at the decoder 206.

In one embodiment, the switch 302 is an embedded chip, such as an Erasable Programmable Read Only Memory (EPROM) chip, which will not lose its memory when the power is turned off. This EPROM will act as an on-off switch between the raw input television signal 110 and the output of the decoder 206. The EPROM would be programmed to output the raw input television signal 110, unless it detected an output video signal from the decoder 206. Someone skilled in the art of programming could easily create the code for programming the EPROM to behave in this manner. For example, the switch 302 could be programmed to detect the first bit of output at the decoder 206 or simply detect the signal from the D/A converter 210 as it is received into the switch 302, and then switch from the raw input television signal 110 to the recorded signal from the decoder 206. Furthermore, the EPROM can be configured to output a pre-programmed message to inform the user that the system is loading, so that the user will understand that the features of the digital network recorder are not yet usable.

In another embodiment, the switch 302 is embodied as a Metal Oxide Semiconductor Field Effect Transistor (MOSFET) such as used in conventional VCRs to provide RF switches between VCR outputs and television signals. Such RF switching MOSFETs are known in the art and commercially available, for example, Phillips Electronics Part No. BF1107, is an n-channel single gate MOSFET and would be suitable as the switch 302.

Thus, the switch 302 behaves similarly to the operation of VCRs in that when the user presses stop for the video cassette, the VCR player stops and the RF signal is passed directly through to the television. Similarly, when the decoder 206 of the digital network recorder is not outputting a recorded video signal, then the switch 302 outputs the raw input television signal 110.

In other embodiments, the switch 302 is not required; however, the RF passthrough is implemented in software by the operating system. In such embodiments, the input television signal 110 must be made coupleable to the output television signal 112. However, in such embodiments, if there is a failure of the operating system, then the system will be unable to switch to the raw input television signal 110; thus, the viewer will not see any programming. The software embodiment is described further below.

It is noted that the A/D converter 202 is optional depending on the system. For example, if the input television signal 110 is already digitized, then the A/D converter 202 is not required. Likewise, in some embodiments, the encoder 204 is not required where a digital input television signal is already in encoded and compressed according to the decoder 206 scheme of the digital network recorder. Additionally, in other embodiments, the D/A converter 208 is not required if the output television signal is to be digital for a digital television. The memory 208 preferably takes the form of a hard disk, but may be other types of digital memory storage, such as a memory stick, as known and produced by Sony Electronics, Inc., of Park Ridge, N.J.

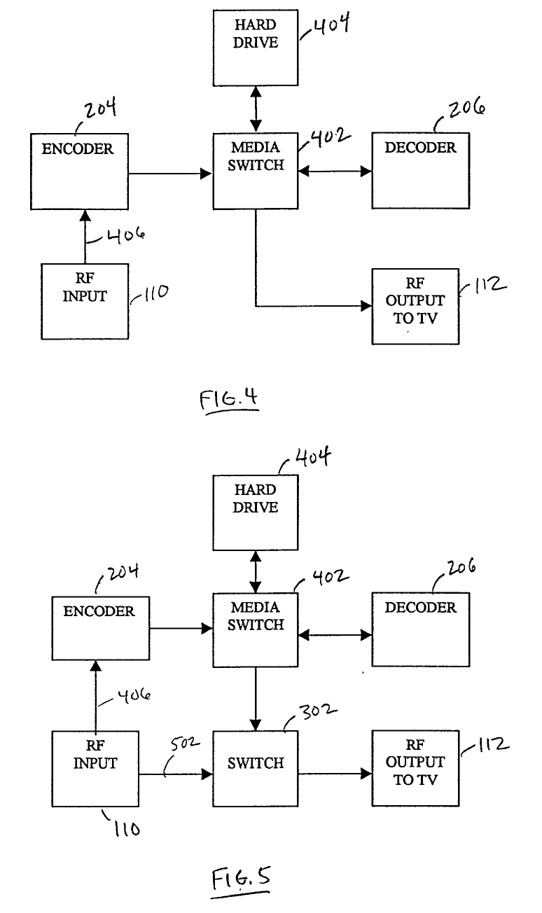

Referring next to FIG. 4, an internal block diagram illustrating several components found within one variation of the conventional digital network recorder of FIG. 1 is shown. Illustrated are the input television signal 110 including an s-video/RCA signal 406, the encoder 204, a media switch 402, the decoder 206, a hard drive 404 (also referred to as a hard disk 404 or generically as a memory 208), and the output television signal 112. It is noted that there are many other internal components to the conventional digital network recorder; however, only the relevant components are shown. This is a similar internal configuration as found in the Sony SVR-2000 as described above.

The s-video/RCA signal 406 of the input television signal 110 is input into the encoder 204 to be encoded according to the MPEG2 standard. Note that the s-video/RCA signal 406 is in digital format; thus, the A/D converter 202 is not needed. Next, the encoded signal is passed to the media switch 402, which is coupled to the hard drive 404 and the decoder 206. The media switch 402 outputs the output television signal 112 to the television.

The media switch 402 is typically in the form of an application specific integrated circuit (ASIC) chip that acts as a gate or switch to control the flow of television signals therethrough. For example, as is common, the media switch 402 is open or closed depending on the whether the user has selected RF channel 2, 3, or 4. Such media switches 402 are well known in the art. The media switch 402 routes the encoded signal from the encoder 204 to be stored on the hard drive 404. It is noted that in some digital delivery systems, such as via a satellite delivery system, the input signal may be already encoded according to the MPEG2 standard, or other suitable standard; thus, the encoder 204 is optional.

Next, the decoder 206 retrieves the encoded stored data from the hard drive 404 via the media switch 400 and decodes the data using the same coding scheme, e.g., MPEG2. In one embodiment, the decoder 206 then converts the signal to analog, in the event the television is an analog television. Then, the decoder 206 outputs the decoded video signal via the media switch 402 as the output television signal 112.

It is noted that the television input signal 110 that is coupled to the encoder 204 in the Sony SVR-2000 is the signal received from s-video inputs and RCA inputs, i.e., the s-video/RCA signal 406, to the digital network recorder, while the RF connectors are not used. S-video, RCA and RF connectors are well known in the art of video equipment.

As stated above, when the digital network recorder is booting up, i.e. the operating system is being loaded from the hard drive into random access memory, the encoder 204, the decoder 206 and the media switch 402 are not outputting an output television signal 112; thus, the user is unable to view any television signal. It is only after the operating system has loaded and verified the functionality of the digital network recorder that the internal loop of recording and then outputting the television signal to the television can begin. This results in the viewer having to endure several minutes of waiting to see the programming.

Similarly, in the event of a hard drive crash or failure, the decoder 206 will cease to output the output television signal 112 and again, the viewer will be unable to view any television programming at the television. Thus, the output television signal will not reach the television, so that the viewer will not see anything on the television screen.

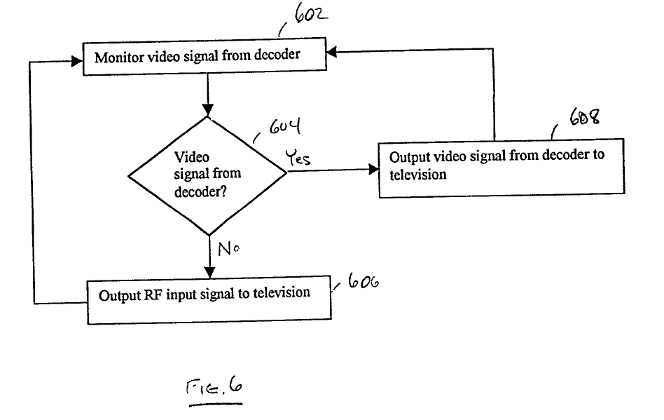

Referring next to FIG. 5, an internal block diagram of one embodiment of the digital network recorder of FIG. 3 is shown in accordance with one embodiment of the invention. Illustrated are the television input signal 110 comprising the s-video/RCA signal 406 and an RF connector signal 502, the encoder 204, the media switch 402, the decoder 206, the hard drive 404, the switch 302, and the output television signal 112. This embodiment of the invention differs from the system of FIG. 4 in that the switch 302 is coupled to the output of the media switch 402. As such, the switch 302 inputs the output of the decoder 206 (via the media switch 402) and also the RF connector signal 502 of the input television signal 110. The output of the switch 302 is the output television signal 112, which is either the raw input television signal 110 (i.e., the signal in the RF connector signal 502) or the decoder 206 output. Thus, the input television signal 110 is coupled to both the encoder 204 (via the s-video/RCA signal 406 in digital format) and also to the switch 302 (via the RF connector signal 502 in analog format).

The switch 302 is as described with reference to FIG. 3, in that it is configured to output the raw input television signal (i.e. the RF connector signal 502), unless there is an output from the decoder 206 (via the media switch 402). Advantageously, the RF connector signal 502 has not digitized, encoded, stored, or decoded at all. It is merely in the raw input television signal 110. Thus, the raw input television signal 110 passes through the digital network recorder. In the event that there is an output at the decoder 206, then the raw input television signal is overwritten by the output of the decoder 206. Thus, when there is no output signal from the decoder, the output television signal is the raw input television signal and when there is an output at the encoder/decoder, then the output television signal is the output signal from the encoder/decoder which is continuously being recorded.

Advantageously, as described with reference to FIG. 3, this system covers the boot up scenario as well as the hard drive crash scenario. Furthermore, as described above, the switch 302 may be embodied as an embedded chip which will retain its memory in the event of power loss, such as an EPROM chip. Alternatively, the switch 302 may be a MOSFET used for RF switching in VCRs and DVDs.

In other embodiments, the switch 302 is not required; however, the passthrough is implemented in software by the operating system. For example, the operating system will instruct the media switch 402 to output the raw input television signal when the decoder 206 is not ready. In such embodiments, a non-encoded input television signal is coupled to the media switch 402, instead of to the switch 302. For example, the RF connector signal 502 is coupled to the media switch 402. However, in such embodiments, if there is a failure of the operating system which would control the RF passthrough, then the media switch 402 will not be instructed to output the raw input television signal (i.e. the RF connector signal 502) and again, the viewer will not see any programming. Furthermore, in the boot up scenario, there will be some wait period for the operating system to load enough to be able to issue an instruction to media switch to pass the raw input television signal 110 through to the television. This embodiment could be used with the system of FIG. 2, although the software of the operating system would need to be altered. One skilled in the art of programming could easily create the proper software to cause the media switch 402 to output the raw input television 110 and then the recorded signal once the decoder 206 was ready. Additionally, the raw input television signal 110 should be coupled to the media switch 402.

Referring next to FIG. 6, a flowchart is shown of the steps performed by the digital network recorder of FIGS. 3 and 5 in accordance with another embodiment of the invention. Initially, the output of the video decoder is monitored (Step 602). For example, the switch 302 of FIGS. 3 and 5 will detect the presence of a signal output from the decoder 206 preferably by simply detecting when an output video signal from the video decoder is received at the switch (via the media switch or via the D/A converter). The switch can easily detect the first bit of an incoming digital signal or the presence of an analog signal (if the video output of the decoder has been converted back to analog) at the input to the switch. Alternatively, in other embodiments, the operating system monitors the output of the video decoder. Furthermore, the video decoder itself may be configured to send a notification to the switch and/or operating system that it is correctly outputting a video signal. If there is no output at the video decoder (Step 604), then the raw input television signal is output to the television (Step 606). Then, the system will continue to monitor the output of the video decoder (Step 602).

If there is an output at the video decoder (Step 604), i.e. the digital network recorder has recorded and retrieved the recorded signal to be output to the television, then the output video signal from the video decoder is output to the television (Step 608). Note that the output video signal from the decoder is an audio/video signal representing the input television signal. The system then continues to monitor the output of the video decoder (Step 602) to see if there has been any changes.

Advantageously, this covers the situation where the operating system is booting up, since the video decoder will not output a signal yet, the raw input television signal is passed through as the output television signal. When the operating system is fully loaded and the encoder/decoder loop is functioning, then the recorded output at the decoder is output as the output television signal. Likewise, if there is a crash in the hard drive or failure in the operating system, the decoder will cease to have an output and the raw input television signal will be output as the output television signal. Thus, the viewer will not have to endure several minutes of booting up every time the digital network recorder is powered up. Similarly, in the event of hard drive crash or software failure, the user will be able to view the raw input television signal.

While the invention herein disclosed has been described by means of specific embodiments and applications thereof, numerous modifications and variations could be made thereto by those skilled in the art without departing from the scope of the invention set forth in the claims.

What is claimed is:

1. A method comprising:
monitoring an output of a digital video decoder of a digital network recorder that continuously records an input television signal to a memory and continuously decodes and plays the input television signal having been recorded; and
outputting the input television signal to a television, in the event an output video signal is not output from the digital video decoder, wherein the output video signal comprises the input television signal having been previously recorded and decoded.

2. The method of claim 1 further wherein the input television signal comprises a broadcast analog television signal.

3. The method of claim 1 wherein the digital video decoder comprises an MPEG2 video decoder.

4. The method of claim 1 wherein the outputting step comprises outputting the input television signal to the television, in the event the digital network recorder is booting up.

5. The method of claim 1 wherein the outputting step comprises outputting the input television signal to the television, in the event there is an operating system failure of the digital network recorder such that the digital network recorder is unable to produce the output video signal.

6. The method of claim 1 further comprising receiving the input television signal into the digital network recorder.

7. The method of claim 1 further comprising outputting the output video signal to the television, in the event the output video signal is output from the digital video decoder.

8. An RF passthrough system for a digital network recorder comprising:
means for monitoring an output of a digital video decoder of a digital network recorder that continuously records an input television signal to a memory and continuously decodes and plays the input television signal having been recorded; and
means for outputting the input television signal to a television, in the event an output video signal is not output from the digital video decoder, wherein the output video signal comprises the input television signal having been previously recorded and decoded.

9. The system of claim 8 wherein the means for outputting comprise means for outputting the input television signal to the television, in the event the digital network recorder is booting up.

10. The system of claim 8 wherein the means for outputting comprise means for outputting the input television signal to the television, in the event there is an operating system failure of the digital network recorder such that the digital network recorder is unable to produce the output video signal.

11. The system of claim 8 further comprising means for outputting the output video signal to the television, in the event the output video signal is output from the digital video decoder.

12. An RF passthrough system for a digital network recorder comprising:
a memory for continuously storing an input television signal as digital data;
a digital video decoder coupled to the memory for continuously retrieving the digital data, decoding the digital data and outputting an output video signal, wherein the output video signal represents the input television signal and is to be output to a television coupled to the digital network recorder; and
a switch for inputting the input television signal and the output video signal, wherein the switch outputs the input television signal in the event the output video signal is not input from the digital video decoder.

13. The system of claim 12 further comprising a digital video encoder coupled to the memory for receiving the input television signal and encoding the input television signal as the digital data.

14. The system of claim 13 further comprising an analog to digital converter coupled to the encoder for digitizing the input television signal prior to being encoded at the encoder.

15. The system of claim 12 further comprising a digital to analog converter coupled to the digital video decoder and the switch for converting the output video signal to analog prior to being input to the switch.

16. The system of claim 12 wherein the switch comprises an embedded chip.

17. The system of claim 16 wherein the embedded chip comprises a programmable read only memory chip.

18. The system of claim 12 wherein the switch comprises a field effect transistor for passing television signals.

19. The system of claim 12 wherein the digital video decoder comprises an MPEG2 decoder.

20. The system of claim 12 wherein the memory comprises a hard disk.

21. The system of claim 12 further comprising a media switch coupling the digital video decoder, the memory and the switch together.
